(19) United States
(12) Patent Application Publication
(10) Pub. No.: US 2013/0205001 A1
(43) Pub. Date: Aug. 8, 2013

(54) MODIFYING APPLICATION DATA SYNCHRONIZATION BASED ON APPLICATION USAGE FREQUENCY

(71) Applicants: Lisa N. Reed, San Francisco, CA (US); Rashmi Chaudhury, San Ramon, CA (US); Johnny C. Chen, San Jose, CA (US); Bryan C. Gebhardt, Fremont, CA (US); Paul W. Hangas, San Jose, CA (US); Scott I. Putterman, Cupertino, CA (US)

(72) Inventors: Lisa N. Reed, San Francisco, CA (US); Rashmi Chaudhury, San Ramon, CA (US); Johnny C. Chen, San Jose, CA (US); Bryan C. Gebhardt, Fremont, CA (US); Paul W. Hangas, San Jose, CA (US); Scott I. Putterman, Cupertino, CA (US)

(73) Assignee: MOTOROLA MOBILITY, INC., Libertyville, IL (US)

(21) Appl. No.: 13/365,026

(22) Filed: Feb. 2, 2012

(51) Int. Cl. G06F 15/173

(52) U.S. Cl. 709/224

(57) ABSTRACT

A method and apparatus for modifying data synchronization of an application responsive to the frequency of application usage are disclosed. Data describing a frequency with which the application is used is captured by a portable computing device. For example, data describing timestamps when the application receives input or data describing a timestamp when the application was the primary application being executed are captured. It is determined whether the frequency of interaction with which the application is used equals or exceeds a threshold value. For example, the portable computing device determines whether the application has received an input or was the primary application within a predetermined time interval from the current time. Responsive to determining the frequency of interaction with the application does not equal or exceed the threshold value, data synchronization for the application is disabled. In one embodiment, the portable computing device stops data synchronization for the application.

### FIELD OF THE DISCLOSURE

The present disclosure relates generally to portable computing devices and more particularly to modifying data synchronization of applications executed by a portable computing device.

### BACKGROUND

Portable computing devices, such as smartphones or tablet computers, are becoming increasingly powerful and user-friendly. Increased network connectivity has further enhanced portable computing device functionality, allowing portable computing devices to more readily provide a wider range of functionalities and/or data. For example, portable computing devices are commonly used to retrieve or otherwise interact with data stored or maintained by a server, allowing a user to more frequently view, modify or otherwise interact with data on the server.

Portable computing devices frequently include one or more applications exchanging data with a server to synchronize data stored on the portable computing device and data stored on the server. To provide the portable computing device with current data from the server, some applications may poll the server at a regular polling interval to transmit data to the server or retrieve data from the server. Alternatively, some applications may push data from the portable computing device to the server at a periodic interval to update the data stored by the server and/or the server may push data to the portable computing device at the periodic interval.

However, each exchange of data with a server consumes battery resources and processing resources, reducing portable computing device performance. Additionally, most applications continue to synchronize with the server even when not actively being used by a user, so the application continues to consume power and processing resources. This continued data synchronization by applications not being used may result in significant resource consumption impairing portable computing device performance.

### BRIEF DESCRIPTION OF THE DRAWINGS

The accompanying Figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of a computing system in accordance with some embodiments.

FIG. 2 is a block diagram of a portable computing device in accordance with some embodiments.

FIG. 3 is a flow chart of a method for modifying data synchronization of an application responsive to application usage frequency in accordance with some embodiments.

Skilled artisans will appreciate that elements in the Figures are illustrated for simplicity and clarity and have not necessarily been drawn to scale. For example, the dimensions of some of the elements in the Figures may be exaggerated relative to other elements to help to improve understanding of embodiments of the present invention.

The apparatus and method components have been represented where appropriate by conventional symbols in the drawings, showing the specific details that are pertinent to understanding the embodiments of the present invention so as not to obscure the disclosure with details that will be readily apparent to those of ordinary skill in the art having the benefit of the description herein.

### DETAILED DESCRIPTION

The following disclosure describes a method and apparatus for modifying data synchronization of an application executed by a portable computing device responsive to the frequency with which the application is used. Data describing a frequency of interaction with the application is captured by the portable computing device. For example, data describing timestamps when the application receives input and/or data describing a timestamp when the application was the primary application being executed by the portable computing device is captured. The portable computing device determines whether the frequency of interaction with the application equals or exceeds a threshold value. For example, the portable computing device determines whether the application has received an input within a predetermined time interval from the current time, determines whether the application was the primary application within a predetermined time interval from the current time or determines whether the application has received a threshold amount of input within a predetermined time interval. Responsive to determining the frequency of interaction with the application does not equal or exceed the threshold value, the portable computing device disables data synchronization for the application. In one embodiment, the portable computing device halts data synchronization for the application. In another embodiment, the portable computing device increases a data synchronization interval associated with the application to minimize a number of times the application communicates with a server during a time period.

In the following description, for purposes of explanation, numerous specific details are set forth to provide a thorough understanding of the invention. However, it will be apparent to one skilled in the art that the invention can be practiced without these specific details. In other instances, structures and devices are shown in block diagram form in order to avoid obscuring the invention.

### System Overview

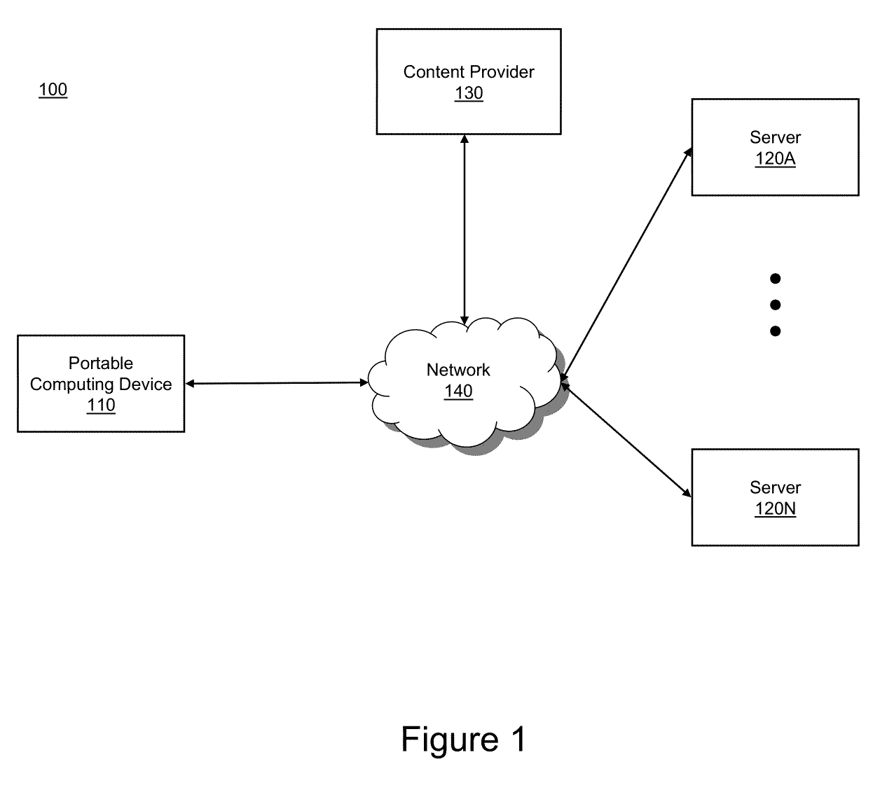

FIG. 1 is a block diagram of one embodiment of a computing system 100. In the embodiment shown by FIG. 1, the computing system 100 includes a portable computing device 110, one or more servers 120A, 120N (also referred to individually and collectively using reference number 120), a content provider 130 and a network 140. However, in different embodiments, the computing system 100 may include different and/or additional components than those depicted by FIG. 1.

The portable computing device 110 is any device with data processing and data communication capabilities. Examples of a portable computing device 110 include a smartphone, a tablet computer, a netbook computer, a laptop computer or any other suitable device. The portable computing device 110 receives data from one or more servers 120A, 120N and/or from a content provider 130 via the network 140. In one embodiment, the portable computing device 110 executes one or more applications that exchange data with one or more servers 120 or a content provider 130. For example, the portable computing device 110 executes an electronic mail (e-mail) client application exchanging data associated with one or more e-mail accounts with one or more servers 120. As another example, the portable computing device 110 executes a social networking application that receives social network data associated with an account from a server 120 and/or transmits social network data associated with the account to the server 120.

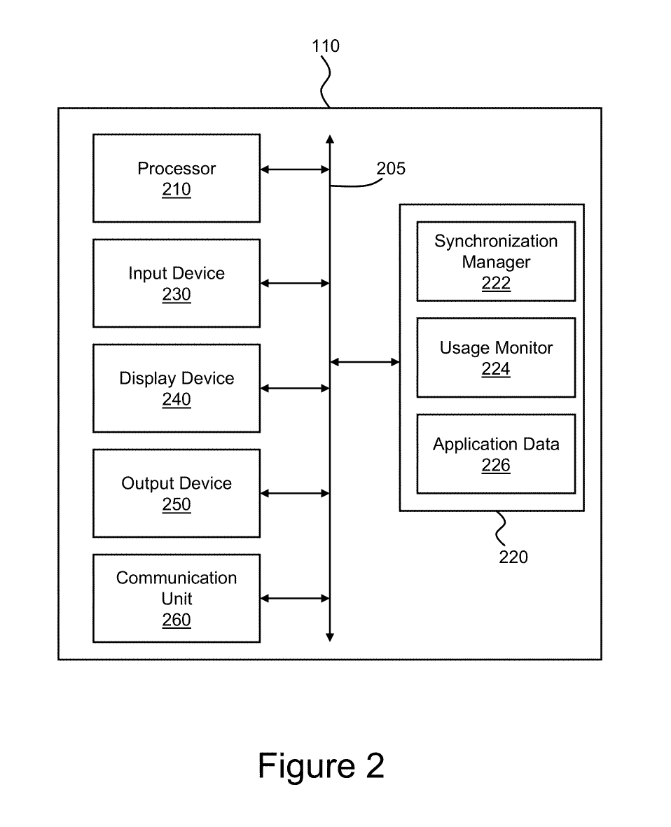

In one embodiment, the portable computing device 110 also receives executable data or instructions from a server 120 via the network 140 that, when executed by the portable computing device 110, executes an application enabling user interaction with content. Additionally, the portable computing device 110 may receive video content, image content or other content from a content provider 130 and present the received content to a user. For example, the portable computing device 110 displays video content from a content provider 130 on a display device. The portable computing device 110 is further described below in conjunction with FIG. 2.

Servers 120A, 120N are computing devices having data processing and data communication capabilities that exchange data with the portable computing device 110 via the network 140. For example, a server 120 provides data such as a web page, audio content, video content, e-mail, calendar information, social networking data or other content via the network 140 to the portable computing device 110 and/or receives data from a portable computing device 110 via the network 140. In one embodiment, a server 120 receives a polling request from the portable computing device 110 via the network 140 at a specified time interval and transmits data to the portable computing device 110 responsive to receiving the polling request or stores data from the portable computing device 110 included in the received polling request. In another embodiment, a server 120 pushes data to the portable computing device 110 using the network 140 at a specified interval.

The content provider 130 comprises one or more computing devices transmitting video content, image content, audio content or other content to the portable computing device 110 via a network 140. For example, the content provider 130 is a video hosting web site, television provider or another source of video, image or audio content. As another example, the content provider 130 is a streaming video source transmitting streaming video content. In one embodiment, the content provider 130 exchanges data with the portable computing device 110 via the network 140 at predetermined intervals either by pushing content to the portable computing device 110 at periodic intervals or by transmitting data to the portable computing device 110 responsive to receiving a polling request from the portable computing device 110.

The network 140 is a conventional type for data, video and/or audio transmission. In various embodiments, the network 140 is a wired network, a wireless network or a combination of wireless and wired networks. The network 140 may have any number of configurations such as a star configuration, a token ring configuration or another configuration known in the art. Furthermore, the network 140 may comprise a local area network (LAN), a wide area network (WAN) (e.g., the Internet), and/or any other interconnected data path across which multiple devices may communicate. In yet another embodiment, the network 140 may be a peer-to-peer network. The network 140 may also be coupled to or include portions of a telecommunications network for sending data in a variety of different communication protocols, such as those used for Transmission Control Protocol/Internet Protocol (TCP/IP), satellite link and/or cable television communication. For example, the network 140 may transmit voice data using one or more of a Global System for Mobile (GSM) communication system, Code Division Multiple Access (CDMA) system, Universal Mobile Telecommunications System (UMTS) or any other suitable protocols.

The network 140 may also transmit data using one or more of General Packet Radio Service (GPRS), third-generation (3G), or greater, mobile network, fourth-generation (4G), or greater, mobile network, High Speed Download Packet Access (HSDPA), High Speed Uplink Packet Access (HSUPA), Long-Term Evolution (LTE), Worldwide Interoperability for Microwave Access (WiMax) or any other suitable protocol. In yet another embodiment, the network 140 includes Bluetooth communication networks or a cellular communications network for sending and receiving data such as via short messaging service (SMS), multimedia messaging service (MMS), hypertext transfer protocol (HTTP), direct data connection, wireless application protocol (WAP), email or other types of data known in the art.

FIG. 2 is a block diagram of one embodiment of a portable computing device 110. In the embodiment shown by FIG. 2, the portable computing device 110 includes a processor 210, a storage device 220, an input device 230, a display device 240, an output device 250 and a communication unit 260 that are coupled together via a bus 205. However, in different embodiments, the portable computing device 110 may include different and/or additional components than those illustrated by FIG. 2.

The processor 210 processes data or instructions and may comprise various computing architectures. For example, the processor 210 processes data or instructions using a complex instruction set computer (CISC) architecture, a reduced instruction set computer (RISC) architecture, an architecture implementing a combination of instruction sets or any other suitable instruction set. Although FIG. 2 shows a single processor 210, in other embodiments, the update manager 150 may include multiple processors. The processor 210 transmits, processes and/or retrieves data from the storage device 220, the input device 230, the display device 240, the output device 250 and/or the communication unit 260.

The storage device 220 stores data and/or instructions that, when executed by the processor 210, cause the processor 210 to perform one or more actions or to provide one or more types of functionality. The data and/or instructions included in the storage device 220 may comprise computer-readable code that, when executed by the processor 210, performs one or more of the methods described herein and/or provide at least a subset of the functionality described herein. The storage device 220 may comprise a dynamic random access memory (DRAM), a static random access memory (SRAM), a hard disk, an optical storage device, a magnetic storage device, a Read Only Memory (ROM), a Programmable Read Only Memory (PROM), an Erasable Programmable Read Only Memory (EPROM), an Electrically Erasable Programmable Read Only Memory (EEPROM), a Flash memory or another memory device known in the art. The storage device 220 may be a persistent storage device, a non-persistent storage device or a combination of a persistent storage device and a non-persistent storage device in various embodiments. The storage device 220 is coupled to the processor 210, the input device 230, the display device 240, the output device 250 and the communication unit 260 via the bus 205.

In the embodiment shown by FIG. 2, the storage device 220 includes a synchronization manager 222, a usage monitor 224 and application data 226. In other embodiments, the storage device 220 may include different and/or additional components than those shown in FIG. 2. The synchronization manager 222 comprises instructions that, when executed by the processor 210, modify the frequency with which an application exchanges data with a server 120 or with a content provider 130. In one embodiment, the synchronization manager 222 stores synchronization intervals and associates a synchronization interval with an application. For example, the synchronization manager 222 associates a polling interval with an application to identify a time between transmission of polling requests to a server 120 or to a content provider 130. As another example, the synchronization manager 222 associates a push interval with an application to specify a time interval between transmission of data to a server 120 or to a content provider 130 or between receipt of data from a server 120 or from a content provider 130. In one embodiment, the synchronization manager 222 associates a synchronization interval with an application by storing the synchronization interval associated with an application identifier.

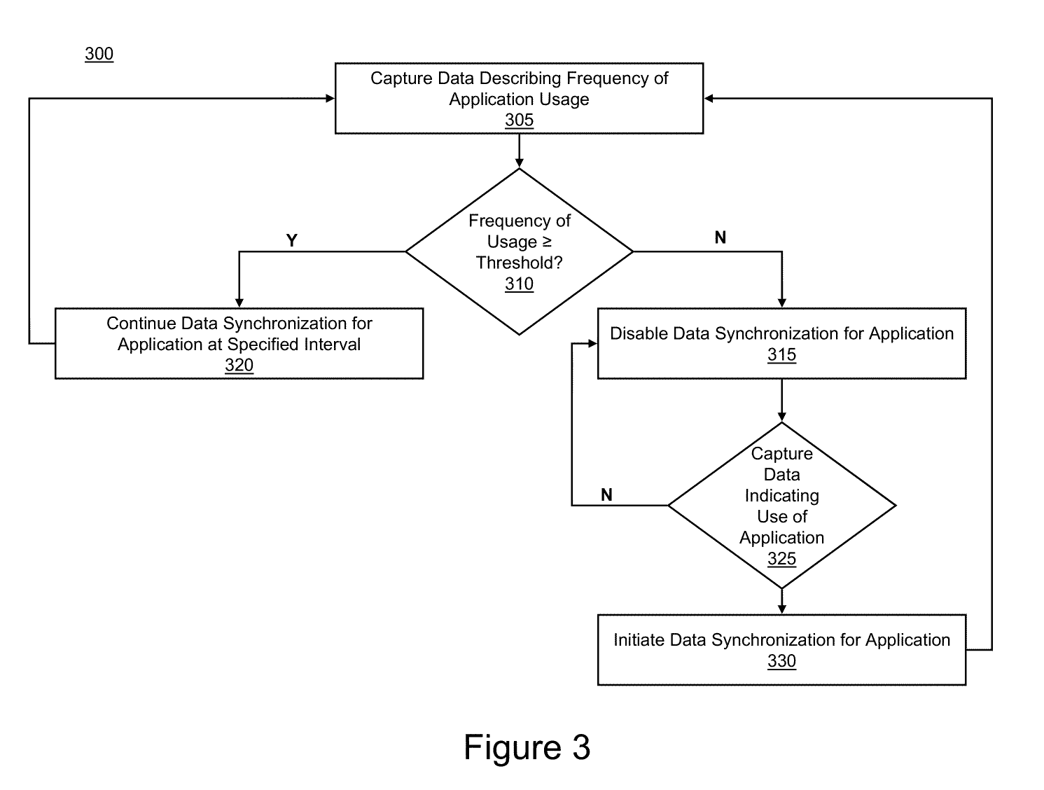

The synchronization manager 222 also includes instructions that, when executed by the processor 210, retrieves data from the usage monitor 224 and modifies the synchronization interval associated with an application based on the frequency with which the application is used. The synchronization manager 222 compares data describing the frequency with which an application is used with a threshold usage amount and reduces the synchronization interval associated with the application responsive to the frequency with which the application is used being less than the threshold usage value. In one embodiment, the synchronization manager 222 stores data associated with an application indicating that data synchronization for the application has been disabled responsive to low frequency of usage of the application, allowing the synchronization manager 222 to continue to store the synchronization interval of the application while data synchronization is disabled. Modification of the synchronization interval associated with an application based on the frequency of application usage is further described below in conjunction with FIG. 3.

The usage monitor 224 comprises instructions that, when executed by the processor 210, capture data describing interaction with one or more applications. The usage monitor 224 associates usage data with an application to indicate the frequency with which the application is used. In one embodiment, the usage monitor 224 is user configurable, allowing a user to apply one or more privacy settings to the captured data. For example, the usage monitor 224 may anonymously capture data describing interaction with an application or may associate captured data with a user.

In one embodiment, the usage monitor 224 captures data indicating a timestamp or timestamps when an application receives input from an input device 230 or from a communication unit 260. As another example, the usage monitor 224 captures data indicating a timestamp when an application is the primary application executed by the processor 210, such as a timestamp when the application uses at least threshold amount of processor resources or a time when the application occupies at least a specified percentage of the display device 240. Additional examples of data captured by the usage monitor 224 include a metric based on a threshold amount of battery life, a metric based on a threshold amount of network usage, a metric based on a threshold amount of network activity, a metric based on a network billing threshold, application usage based a location of the portable computing device 100 when an application exchanged data, a metric based on a network billing threshold or any suitable metric describing data usage by an application. In an additional example, the usage monitor 224 selects an optimal polling interval maximizing battery life, minimizing network usage or optimizing another resource using a user's application usage history.

The application data 226 comprises instructions that, when executed by the processor 210, implement one or more applications providing functionality to a user of the portable computing device 110 or to the portable computing device 110. For example, the application data 226 includes data for executing a web browser, an e-mail client, a social network viewer, a messaging application, a calendar, an image viewer, a text editor, a news aggregator or other application transmitting data to and/or receiving data from a server 120 or a content provider 130 via the network 140. In one embodiment, an application included in the application data 226 is associated with a synchronization interval stored in the synchronization manager 222. The application exchanges data with a server 120 or a content provider 130 at times determined by the synchronization interval. For example an application associated with a synchronization interval of 30 minutes exchanges data with a server at periodic 30 minute intervals.

The input device 230 is any device configured to receive input and to communicate the received input to the processor 210, to the storage device 220 or to another component of the update manager 150. For example, the input device 230 comprises a cursor controller, a touch-sensitive display or a keyboard. In one embodiment, the input device 230 includes an alphanumeric input device, such as a keyboard, a key pad, representations of such created on a touch-sensitive display or another device adapted to communicate information and/or commands to the processor 210 or to the storage device 220. In another embodiment, the input device 230 comprises an input device for communicating positional data as well as data or commands to the processor 210 or to the storage device 220 such as a joystick, a mouse, a trackball, a stylus, a touch-sensitive display, directional keys or another suitable input device known in the art.

In one embodiment, the input device 230 may also include an orientation sensor determining an orientation associated with the portable computing device 110. For example, the orientation sensor comprises a tilt sensor measuring tilting in two or more axes of a reference plane. In one embodiment, the orientation sensor comprises an accelerometer determining an orientation of the portable computing device 110. In one embodiment, the orientation sensor generates a first control signal responsive to determining the portable computing device 110 has a first orientation and generates a second control signal responsive to determining the portable computing device has a second orientation. For example, the orientation sensor generates the first control signal responsive to determining the portable computing device 110 has a first orientation relative to a reference plane and generates the second control signal responsive to determining the portable computing device 110 has a second orientation relative to the reference plane. For example, the orientation sensor generates the first control signal responsive to being perpendicular to a reference plane and generates the second control signal responsive to being parallel to the reference plane. In one embodiment, the first orientation and the second orientation are orthogonal to each other, such as a landscape orientation and a portrait orientation.

The display device 240 is a device that displays electronic images and/or data. For example, the display device 240 comprises an organic light emitting diode display (OLED), a liquid crystal display (LCD) or any other device such as a monitor. In one embodiment, the display device 240 includes a touch-sensitive transparent panel for receiving data or allowing other interaction with the images and/or data displayed by the display device 240.

The output device 250 comprises one or more devices that convey data or information to a user of the portable computing device 110. For example, the output device 250 includes one or more speakers or headphones for presenting audio data to a user. As another example, the output device 250 includes one or more light emitting diodes (LEDs) or other light sources to provide visual data to a user. As another example, the output device 250 includes one or more devices for providing vibrational, or haptic, feedback to a user. The above are merely examples and the output device 250 may include one or more devices for providing auditory output, tactile output, visual output, any combination of the preceding or any other suitable form of output.

The communication unit 260 transmits data from portable computing device 110 to the network 140 or to other portable computing devices 110 and/or receives data from a server 120 or a content provider 130 via the network 140. In one embodiment, the communication unit 260 comprises a wireless transceiver that transmits and/or receives data using one or more wireless communication protocols. For example, the communication unit 260 includes one or more wireless transceivers transmitting and/or receiving data using one or more wireless communication protocols, such as IEEE 802.11a/b/g/n (WiFi), Global System for Mobile (GSM), Code Division Multiple Access (CDMA), Universal Mobile Telecommunications System (UMTS), General Packet Radio Service (GPRS), third-generation (3G), or greater, mobile network, fourth-generation (4G), or greater, mobile network, High Speed Download Packet Access (HSDPA), High Speed Uplink Packet Access (HSUPA), Long-Term Evolution (LTE), Worldwide Interoperability for Microwave Access (WiMax), BLUETOOTH® or another wireless communication protocol. In another embodiment, the communication unit 260 is a network adapter or other type of wired communication port for communicating with the network 140 or with another portable computing device 110 using a wired communication protocol, such as Universal Serial Bus (USB), Ethernet or another suitable wired communication protocol. In yet another embodiment, the communication unit 260 comprises a combination of one or more transceivers and a wired network adapter, or similar wired device.

### Methods

FIG. 3 is a flow chart of a method 300 for modifying data synchronization responsive to frequency of usage of an application. In one embodiment, the steps illustrated by the method 300 shown by FIG. 3 are implemented by instructions for performing the described actions embodied or stored within a non-transitory computer readable storage medium that, when executed by a processor 210, provide the functionality further described below. Examples of a non-transitory computer readable storage medium, such as the storage device 220, include flash memory, random access memory (RAM) or any other suitable medium known to one skilled in the art.

The method 300 may be implemented in embodiments of hardware, software or combinations of hardware and software. In one embodiment, instructions for performing the actions described below are stored in the storage device 220 of the portable computing device 110, such as in the synchronization manager 222, and execution of the instructions by the processor 210 performs the actions described below. Moreover, in some embodiments, the method 300 includes different and/or additional steps than those shown by FIG. 3.

The usage monitor 224 included in a portable computing device 110 captures 305 data describing the frequency with which an application executed by the portable computing device 110 is used. For example, the usage monitor 224 captures 305 data describing interaction with an application and associates a timestamp with the captured data, allowing the usage monitor 224 to indicate a frequency with which the application is used. For example, the usage monitor 224 captures 305 data indicating a timestamp or timestamps when the application receives input from an input device 230 or from a communication unit 260. The usage monitor 224 may capture 305 data indicating a timestamp specifying when the application is the primary application executed by the processor 210, such as a time when the application uses at least threshold amount of processor resources or a time when the application occupies at least a specified percentage of the display device 240.

The synchronization manager 222 retrieves data describing the frequency with which the application is used from the usage monitor 224 and determines 310 whether the frequency with which the application is used equals or exceeds a threshold usage amount. For example, the synchronization manager 222 determines 310 whether the application has received an input within a predetermined time interval from the current time. As another example, the synchronization manager 222 determines whether the application was the primary application within a predetermined time interval from the current time. In one embodiment, the application is determined 310 to be the primary application when the application uses at least a threshold amount of processor resources or occupies at least a threshold amount of a display device 240. In another example, the synchronization manager 222 determines 310 whether the application has received a threshold amount of input within a predetermined time interval. Responsive to determining 310 that the frequency with which the application is used equals or exceeds the threshold usage amount, the synchronization manager 222 continues 320 exchanging data between the application and the server 120 or the content provider 130 using the synchronization interval stored by the synchronization manager 222. The usage monitor 224 continues capturing 305 data describing frequency of usage of the application, as described above.

Responsive to determining 310 the frequency with which the application is used does not equal or exceed the threshold usage amount, the synchronization manager 222 disables 315 data synchronization for the application. For example, the synchronization manager 222 disables 315 data synchronization by stopping exchange of data between the application and a server 120 or the content provider 130. In one embodiment, the synchronization manager 222 retains the synchronization interval associated with the application but stores additional data associated with the application indicating that exchange of data between the application and the server 120 or the content provider 130 is stopped. As another example, the synchronization manager 222 disables 315 data synchronization between the application and the server 120 or the content provider 130 by increasing the synchronization interval associated with the application. In one embodiment, the synchronization manager 222 increases the synchronization interval to a maximum value that minimizes the frequency with which the application exchanges data with the server 120 or with the content provider 130 during a time period. For example, the synchronization manager 222 increases the synchronization interval so the application exchanges data with the server 120 or with the content provider 130 once per twenty-four hours or once per thirty-six hours.

When data synchronization between the application and the server 120 or the content provider 130 is disabled 315, the synchronization manager 222 determines 325 whether the usage monitor 224 captures data indicating use of the application. For example, the synchronization manager 222 determines 325 whether the usage monitor 224 captures data indicating the application has received an input from the input device 230 within a specified time interval from the current time, captures data indicating the application is currently the primary application executed by the processor 210 or captures data indicating the application was the primary application executed by the processor 210 within a specified time interval from the current time. Responsive to determining 325 the usage monitor 224 has not captured data indicating use of the application, data synchronization of the application remains disabled 315 by the synchronization manager 222.

However, responsive to determining 325 the usage monitor 224 has captured data indicating use of the application, the synchronization manager 222 initiates 330 synchronization of data between the application and the server 120 or the content provider 130. For example, if the application is currently the primary application executed by the processor or was the primary application executed by the processor within 15 minutes of the current time, the synchronization manager 222 determines 325 the usage monitor 224 includes data indicating use of the application. In one embodiment, the synchronization manager 222 initiates 330 a data exchange between the application and the server 120 or the content provider 130 at the time the synchronization manager 222 determines 325 the usage monitor 224 has captured data indicating use of the application. Data is then subsequently exchanged between the application and the server 120 or the content provider 130 according to the stored synchronization interval associated with the application. After initiating 330 data synchronization between the application and the server 120 or the content provider 130, the usage monitor 224 captures 305 data describing frequency of usage of the application and the method 300 proceeds as described above.

By disabling 315 data exchange between an application and a server 120 or a content provider 130 responsive to the frequency of usage of the application being less than a threshold usage amount, the method 300 beneficially conserves power and/or processing resources consumed by a portable computing device 110. Further, after exchange between the application and the server 120 or the content provider 130 has been disabled 315, the method 300 initiates 330 data synchronization again when data is captured indicating use of the application to update data between the application and the server 120 or the content provider 130 when the application is used. Hence, the method 300 conserves portable computing device 110 resources by reducing or stopping the exchange of synchronization data between an application that is not being, or is infrequently being, used and a server 120 or a content provider 130. Additionally, the method 300 allows reduction of network resource usage, which may also reduce monetary costs associate with network resource usage.

Application usage data from multiple portable computing devices 110 may be collected and stored by a server 120. For example, a server 120 collects anonymous user data from multiple portable computing devices 110. Based on received usage data the server 120 determines an optimal synchronization interval for a group of users having similar application usage data. In one embodiment the server 120 uses additional information when determining the optimal synchronization interval. For example, the server 120 accounts for user demographic and/or other analytic data when determining the optimal synchronization interval for a group of users.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “ha . . . a,” “includes . . . a,” or “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. In some embodiments, a combination of the two approaches may be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method comprising:
capturing, by a portable computing device, data describing a frequency with which an application executed by the portable computing device is used, the application exchanging data with a server at a synchronization interval associated with the application stored by the portable computing device;
determining, by the portable computing device, whether the frequency with which the application executed by the portable computing device is used equals or exceeds a threshold usage amount; and
responsive to determining the frequency with which the application executed by the portable computing device is used does not equal or exceed the threshold usage amount, disabling the exchange of data between the application executed by the portable computing device and the server.

2. The method of claim 1, further comprising:
responsive to disabling the exchange of data between the application executed by the portable computing device and the server, determining whether captured data indicates use of the application executed by the portable computing device; and
responsive to determining captured data indicates the use of the application executed by the portable computing device, exchanging data between the application executed by the portable computing device and the server.

3. The method of claim 2, wherein determining whether captured data indicates use of the application executed by the portable computing device comprises:
determining whether captured data indicates the application executed by the portable computing device has received an input within a specified time interval from a current time.

4. The method of claim 2, wherein determining whether captured data indicates use of the application executed by the portable computing device comprises:
determining whether captured data indicates the application executed by the portable computing device is currently a primary application executed by a processor of the portable computing device.

5. The method of claim 2, wherein determining whether captured data indicates use of the application executed by the portable computing device comprises:
determining whether captured data indicates the application executed by the portable computing device was a primary application executed by a processor of the portable computing device within a specified time interval from a current time.

6. The method of claim 1, wherein capturing, by the portable computing device, data describing the frequency with which the application executed by the portable computing device is used comprises at least one of:
capturing a timestamp when the application receives an input from an input device, capturing a timestamp when the application receives an input from a communication unit or capturing a timestamp when the application is a primary application executed by a processor included in the portable computing device.

7. The method of claim 6, wherein capturing the timestamp when the application is the primary application executed by the processor included in the portable computing device comprises:
capturing a timestamp when the application uses a threshold amount of resources of the processor or when the application occupies at least a specified percentage of a display device.

8. The method of claim 1, wherein responsive to determining the frequency with which the application executed by the portable computing device is used does not equal or exceed the threshold usage amount, disabling the exchange of data between the application executed by the portable computing device and the server comprises:
responsive to determining captured data does not include a timestamp associated with the application executed by the portable computing device receiving an input is not within a predetermined time interval from a current time, disabling the exchange of data between the application executed by the portable computing device and the server.

9. The method of claim 1, wherein responsive to determining the frequency with which the application executed by the portable computing device is used does not equal or exceed the threshold usage amount, disabling the exchange of data between the application executed by the portable computing device and the server:
responsive to determining captured data does not include a threshold amount of input received by the application executed by the portable computing device within a predetermined time interval from a current time, disabling the exchange of data between the application executed by the portable computing device and the server.

10. The method of claim 1, wherein responsive to determining the frequency with which the application executed by the portable computing device is used does not equal or exceed the threshold usage amount, disabling the exchange of data between the application executed by the portable computing device and the server comprises:
responsive to determining captured data does not include a timestamp associated with the application executed by the portable computing device being the primary application executed by a processor of the portable computing device within a predetermined time interval from a current time, disabling the exchange of data between the application executed by the portable computing device and the server.

11. The method of claim 1, wherein disabling the exchange of data between the application executed by the portable computing device and the server comprises:
stopping exchange of data between the application executed by the portable computing device and the server.

12. The method of claim 1, wherein disabling the exchange of data between the application executed by the portable computing device and the server comprises:
modifying the synchronization interval associated with the application.

13. An apparatus comprising:
a processor;
a non-transitory computer readable storage device coupled to the processor, the non-transitory computer readable storage device including instructions that, when executed by the processor, cause the processor to:
capture data describing a frequency with which an application executed by the processor is used, the application exchanging data with a server at a synchronization interval associated with the application;
determine whether the frequency with which the application executed by the processor is used equals or exceeds a threshold usage amount; and
responsive to determining the frequency with which the application executed by the processor is used does not equal or exceed the threshold usage amount, disabling the exchange of data between the application executed by the processor and the server.

14. The apparatus of claim 13, wherein the non-transitory computer readable storage device further includes instructions that, when executed by the processor, cause the processor to:
responsive to disabling the exchange of data between the application executed by the processor and the server, determine whether captured data indicates use of the application executed by the processor; and
responsive to determining captured data indicates the use of the application executed by the processor, exchange data between the application executed by the processor and the server.

15. The apparatus of claim 14, wherein determine whether captured data indicates use of the application executed by the processor comprises:
determining whether captured data indicates the application executed by the processor has received an input within a specified time interval from a current time.

16. The apparatus of claim 14, wherein determine whether captured data indicates use of the application executed by the processor comprises:
determining whether captured data indicates the application executed by the processor is currently a primary application executed by the processor.

17. The apparatus of claim 14, wherein determine whether captured data indicates use of the application executed by the processor comprises:
determining whether captured data indicates the application executed by the processor was a primary application executed by the processor within a specified time interval from a current time.

18. The apparatus of claim 13, wherein capture data describing the frequency with which the application executed by the processor comprises at least one of:
capturing a timestamp when the application receives an input from an input device, capturing a timestamp when the application receives an input from a communication unit or capturing a timestamp when the application is a primary application executed by the processor.

19. The apparatus of claim 18, wherein capturing the timestamp when the application is the primary application executed by the processor comprises:
capturing a timestamp when the application uses a threshold amount of resources of the processor or when the application occupies at least a specified percentage of a display device.

20. The apparatus of claim 13, wherein responsive to determining the frequency with which the application executed by the processor is used does not equal or exceed the threshold usage amount, disable the exchange of data between the application executed by the processor and the server comprises:
responsive to determining captured data does not include a timestamp associated with the application executed by the portable computing device receiving an input is not within a predetermined time interval of a current time, disabling the exchange of data between the application executed by the processor and the server.

21. The apparatus of claim 13, wherein responsive to determining the frequency with which the application executed by the processor is used does not equal or exceed the threshold usage amount, disable the exchange of data between the application executed by the processor and the server:
responsive to determining captured data does not include a threshold amount of input received by the application executed by the processor within a predetermined time interval from a current time, disabling the exchange of data between the application executed by the processor and the server.

22. The apparatus of claim 13, wherein responsive to determining the frequency with which the application executed by the processor is used does not equal or exceed the threshold usage amount, disabling the exchange of data between the application executed by the processor and the server comprises:
responsive to determining captured data does not include a timestamp associated with the application executed by the processor being a primary application executed by the processor of the portable computing device within a predetermined time interval from a current time, disabling the exchange of data between the application executed by the processor and the server.

23. The apparatus of claim 13, wherein disable the exchange of data between the application executed by the processor and the server comprises:
stopping exchange of data between the application executed by the processor and the server.

24. The apparatus of claim 13, wherein disable the exchange of data between the application executed by the processor and the server comprises:
Imodifying the synchronization interval associated with the application.

25. A non-transitory computer readable storage medium including instructions that, when executed by a processor, cause the processor to:
capture data describing a frequency with which an application executed by the processor is used, the application exchanging data with a server at a synchronization interval associated with the application;
determine whether the frequency with which the application executed by the processor is used equals or exceeds a threshold usage amount; and
responsive to determining the frequency with which the application executed by the processor is used does not equal or exceed the threshold usage amount, disabling the exchange of data between the application executed by the processor and the server.

26. The non-transitory computer readable storage medium of claim 25, further including instructions that, when executed by the processor, cause the processor to:
responsive to disabling the exchange of data between the application executed by the processor and the server, determine whether captured data indicates use of the application executed by the processor; and
responsive to determining captured data indicates the use of the application executed by the processor, exchange data between the application executed by the processor and the server.

27. The non-transitory computer readable storage medium of claim 25, wherein disable the exchange of data between the application executed by the processor and the server comprises:
stopping exchange of data between the application executed by the processor and the server.

28. The non-transitory computer readable storage medium of claim 25, wherein disable the exchange of data between the application executed by the processor and the server comprises:
increasing the synchronization interval associated with the application.
